(19) United States
(12) Patent Application Publication
(10) Pub. No.: US 2022/0099363 A1
(43) Pub. Date: Mar. 31, 2022

(54) FOOD HOLDING APPARATUS

(71) Applicant: Duke Manufacturing Co., St. Louis, MO (US)

(72) Inventor: James W. Bigott, Fenton, MO (US)

(21) Appl. No.: 17/448,901

(22) Filed: Sep. 27, 2021

Related U.S. Application Data
(60) Provisional application No. 63/083,547, filed on Sep. 25, 2020.

(51) Int. Cl. F25D 31/00; F25D 11/02; F25D 29/00; A47J 36/24; A47J 39/00

(52) U.S. Cl. CPC F25D 31/005; F25D 31/006; F25D 11/025; F25D 2700/121; A47J 36/2483; A47J 39/006; F25D 2400/08; F25D 29/005

(57) ABSTRACT

A food holding apparatus and associated components and methods. The food holding apparatus includes at least one food receiver and a refrigeration system. First and second cooling conduits are arranged with respect to the receiver and configured to receive refrigerant to refrigerate a tray of food disposed in a cavity of the receiver. A metering valve is fluidly coupled to the second cooling conduit to selectively block and permit flow of refrigerant to the second cooling coil.

### CROSS-REFERENCE TO RELATED APPLICATION

The present application claims priority to U.S. Provisional Application No. 63/083,547, filed on Sep. 25, 2020, the entirety of which is hereby incorporated by reference.

### FIELD

The present disclosure generally relates to food holding apparatus and more particularly to apparatus for holding food at hot and/or cold temperatures.

### BACKGROUND

Food holding apparatus, such as countertop food holding apparatus, are commonly used in restaurants and kitchens, such as part of a buffet or serving line, to hold prepared food at a set temperature before the food is served to a consumer.

### SUMMARY

In one aspect, a food holding apparatus comprises a housing and at least one food receiver supported by the housing. The at least one food receiver defines a cavity sized and shaped to receive a tray of food. A refrigeration system associated with the food receiver comprises a first cooling conduit arranged with respect to the receiver and configured to receive refrigerant to refrigerate the tray of food when the tray of food is disposed in the cavity of the food receiver. A second cooling conduit is arranged with respect to the receiver and configured to receive refrigerant to refrigerate the tray of food when the tray of food is disposed in the cavity of the food receiver. A refrigerant supply system is fluidly coupled to the first and second cooling conduits to supply the first and second conduits with refrigerant. A metering valve is fluidly coupled to the second cooling conduit to selectively block and permit flow of refrigerant to the second cooling conduit such that refrigerant can flow through the first cooling conduit while refrigerant is blocked from flowing through the second cooling conduit.

In another aspect, a method of conditioning food comprises positioning the food in a cavity of a receiver of a food holding apparatus. The food holding apparatus includes a first cooling conduit configured to refrigerate the tray of food in the cavity and a second cooling conduit configured to refrigerate the tray of food in the cavity. The first cooling conduit is arranged for refrigerant to flow therethrough while refrigerant is selectively blocked from flowing through the second cooling conduit. The method includes cooling the tray of food with at least one of the first cooling conduit or second cooling conduit.

Other objects and features will be in part apparent and in part pointed out hereinafter.

### BRIEF DESCRIPTION OF THE DRAWINGS

FIG. 1 is a perspective of a food holding apparatus according to one embodiment of the present disclosure;

FIG. 2 is a front view of the food holding apparatus;

FIG. 3 is a cross section of the food holding apparatus taken through line 3-3 of FIG. 1;

FIG. 4 is a cross section of the food holding apparatus taken through line 4-4 of FIG. 1;

FIG. 5 is an enlarged, fragmentary cross section of the food holding apparatus taken from FIG. 3;

FIG. 6 is a schematic of a refrigeration system of the food holding apparatus;

FIG. 7 is a cross section of the food holding apparatus taken through line 7-7 of FIG. 3; and

FIG. 8 is a schematic of a control system for the food holding apparatus.

Corresponding reference characters indicate corresponding parts throughout the drawings.

### DETAILED DESCRIPTION

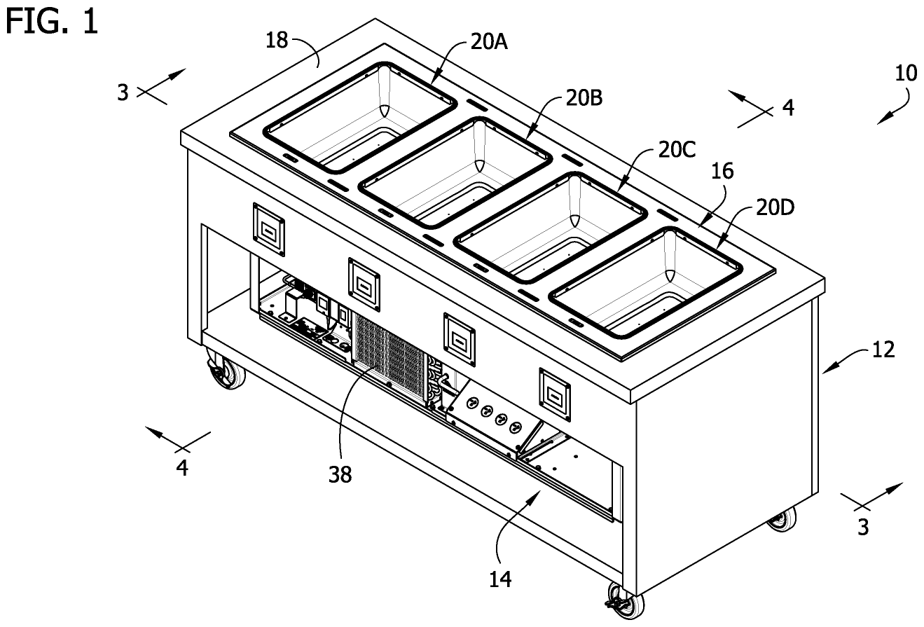

Referring to the drawings, FIG. 1 illustrates one embodiment of food holding apparatus according to the present disclosure, indicated generally at reference numeral 10. The food holding apparatus 10 may be used to hold trays of prepared or ready to serve food at set temperatures. Specifically, the food holding apparatus 10 is suited to cool trays of food to different temperatures. As will become apparent, the food holding apparatus 10 can heat and/or cool multiple different trays of food at the same time and to different temperatures.

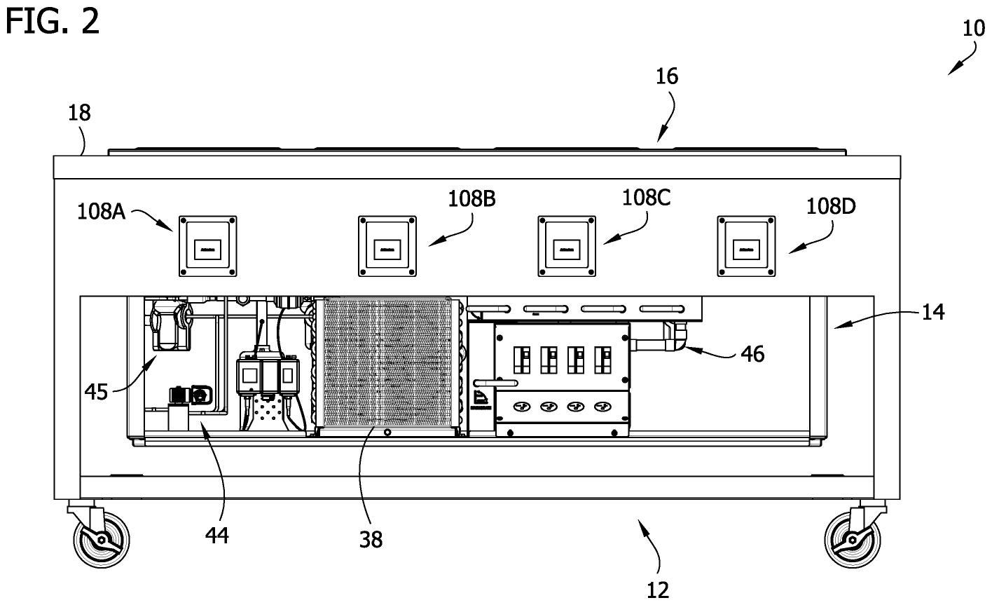

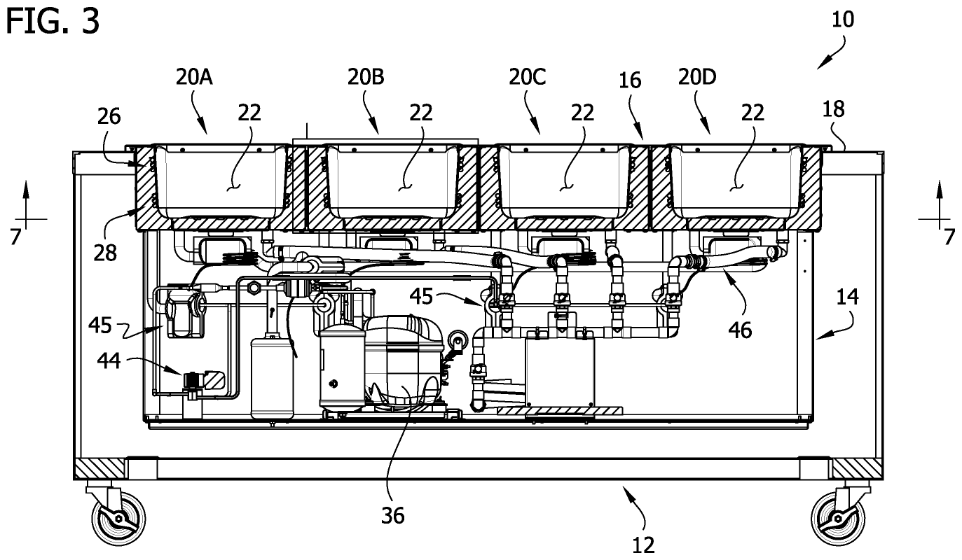

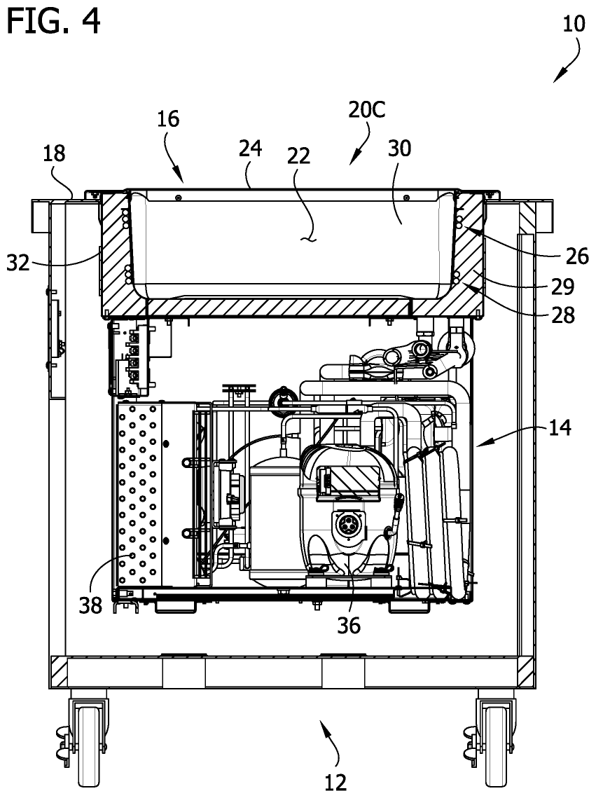

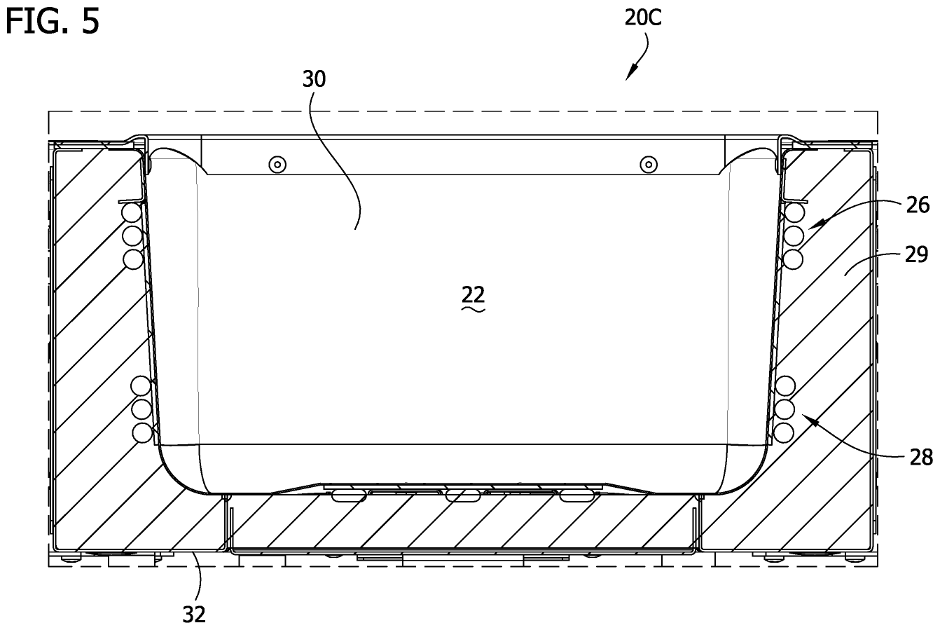

Referring to FIGS. 1-6, the food holding apparatus 10 includes a cabinet or food bar, generally indicated by reference numeral 12, The food holding apparatus 10 includes a housing or framework 14 supporting a counter or upper portion 16. The upper portion 16 is configured to receive and hold one or more trays of food (not shown). The cabinet 12 defines or includes a food serving countertop 18 from which food from the one or more trays may be served, with the upper portion 16 of the housing 14 generally disposed at the countertop. In one embodiment, the housing 14 (and associated components supported thereby) may be a self-contained unit (e.g., “drop-in”) that is dropped into the cabinet 12 and supported by the cabinet. The upper portion 16 includes one or more receivers 20 (food receivers) configured to receive the trays of food. In the illustrated embodiment, the food holding apparatus 10 includes four receivers 20A-D, however more or fewer receivers are within the scope of the present disclosure. For example, the food holding apparatus 10 can include one, two, three, five or more receivers 20. The receivers 20A-D are generally identical. Each receiver 20 defines a cavity 22 with an open top 24. The open top 24 is adjacent to or at (e.g., generally co-planar with) the food serving countertop 18. Each cavity 22 is sized and shaped to receive and hold one or more trays of food. Each tray of food is inserted into the cavity 22 through the open top 24. Each receiver 20 may also be fluidly connected to a drainage system 46 in order to drain fluid, such as water, from the cavity 22 of each receiver.

The tray of food is able to be cooled and/or kept at a cool temperature (e.g., a temperature below room temperature, a refrigeration temperature, a freezing temperature) when the tray of food is in the receiver 20. Each receiver 20 is associated with at least one cooling element for cooling the receiver. In the illustrated embodiment, each receiver 20 is associated with two cooling elements. The cooling elements comprise a first cooling coil 26 and a second cooling coil 28. Each coil 28 comprises a cooling conduit such as a copper tube. The first and second cooling coils 26, 28 are each arranged with respect to their associated receiver 20 to cool the receiver. The first and second cooling coils 26, 28 are configured to receive refrigerant to cool (e.g., refrigerate) the tray of food when the tray of food is disposed in the cavity 22 of the receiver 20. The cavity 22 of the receiver 20 may be cooled with either one of or both of the cooling coils 26, 28 (e.g., at least one of the cooling coils). Each of the first and second cooling coils 26, 28 wrap around the cavity 22. In the illustrated embodiment, the cooling coils 26, 28 wrap approximately three times around the cavity 22 although more or fewer wraps are within the scope of the present disclosure. In the illustrated embodiment, each receiver 20 is double walled, with insulation 29 disposed between the walls. The receiver 20 includes a pan 30 (e.g., a lower wall, first and second side walls, and first and second end walls) and a housing 32 (e.g., a lower wall, an upper wall, first and second side walls, and first and second end walls). The pan 30 defines the cavity 22. Each of the first and second cooling coils 26, 28 are disposed between the pan and housing 30, 32, and desirably adjacent (e.g., engaged to) the pan 30. The insulation 29 surrounds the first and second cooling coils 26, 28. The first cooling coil 26 associated with each receiver 20 is disposed adjacent to an upper end of the respective receiver 20. The first cooling coil 26 is disposed above the second cooling coil 28. The second cooling coil 28 is adjacent to a lower end of the respective receiver 20. In the illustrated embodiment, the second cooling coil 28 wraps around the lower portion of the side and end walls of the pan 30. In other embodiments, the second cooling coil 28 may extend under the lower wall of the pan 30 to underlie the cavity 22. In one embodiment, the first and second cooling coils 26, 28 may have different lengths. Generally, the longer the cooling coil 26, 28 the more cooling provided by the coil. In one embodiment, the second cooling coil 28 is longer than the first cooling coil 26 to provide more cooling than the first cooling coil.

Referring to FIGS. 1-4 and 6, the first and second cooling coils 26, 28 for each receiver 20 are part of a refrigeration system 34 of the food holding apparatus 10. The refrigeration system 34 is associated with each receiver 20 to cool the tray of food disposed in each receiver. The refrigeration system 34 is generally supported by and in the interior of the housing 14. The refrigeration system 34 moves refrigerant through the first and/or second cooling coils 26, 28 (which, broadly, act as an evaporator) associated with each receiver 20 to cool the cavity 22 of the receiver, thereby cooling the tray of food held in the receiver. The refrigeration system 34 also includes a compressor 36, a condenser 38, and plumbing, generally indicated at 40. The plumbing 40 fluidly connects the various components of the refrigeration system 34 together in a loop. For example, the plumbing 40 fluidly connects the compressor 36, the condenser 38 and the first and second cooling coils 26, 28 together. The plumbing 40 may include pipes, fittings, valves (e.g., ball valves, solenoid valves), manifolds, etc. to fluidly connect the components of the refrigeration system 34 together. Broadly, the compressor 36 and condenser 38 may be of a refrigerant supply system (e.g., a condensing unit) that supplies the first and second cooling coils 26, 28 associated with each receiver 20 with refrigerant. Persons having ordinary skill in the art will understand that the surrounding environment (e.g., cavity 22 and the tray of food) will be cooled by the first and/or second cooling coil 26, 28 as the refrigerant flows through the coil(s).

The refrigeration system 34 also includes a refrigerant receiver 42, a refrigerant metering valve 44 (e.g. a solenoid valve), and an expansion valve 45 associated with each cooling coil 26, 28. In other words, the first and second cooling coils 26, 28 for each receiver 20 are each associated with their own respective refrigerant receiver 42, refrigerant metering valve 44, and expansion valve 45. In some embodiments, the refrigerant metering valve and expansion valve may be integrated into a single component (e.g., valve). In the illustrated embodiment, the refrigeration system 34 includes eight refrigerant receivers 42, eight expansion valves 45, and eight refrigerant metering valves 44 (e.g. metering valves 44A₁, 44A₂, 44B₁, 44B₂, 44C₁, 44C₂, 44D₁, 44D₂) one of each associated with one of the two (e.g., first and second) cooling coils 26, 28 of the four receivers 20A-D (e.g., eight cooling coils total). For example, refrigerant metering valve 44A₁ is associated with the first cooling coil 26 associated with the first receiver 20A, refrigerant metering valve 44A₂ is associated with the second cooling coil 28 associated with the first receiver 20A, refrigerant metering valve 44B₁ is associated with the first cooling coil 26 associated with the second receiver 20B, and so on. Other configurations are within the scope of the present disclosure. For example, the refrigeration system 34 may include one refrigerant receiver 42 associated with all the cooling coils 26, 28. Each refrigerant metering valve 44 is fluidly coupled to its respective cooling coil 26, 28 (e.g., the first cooling coil or the second cooling coil) to selectively block and permit the flow of refrigerant to the respective cooling coil.

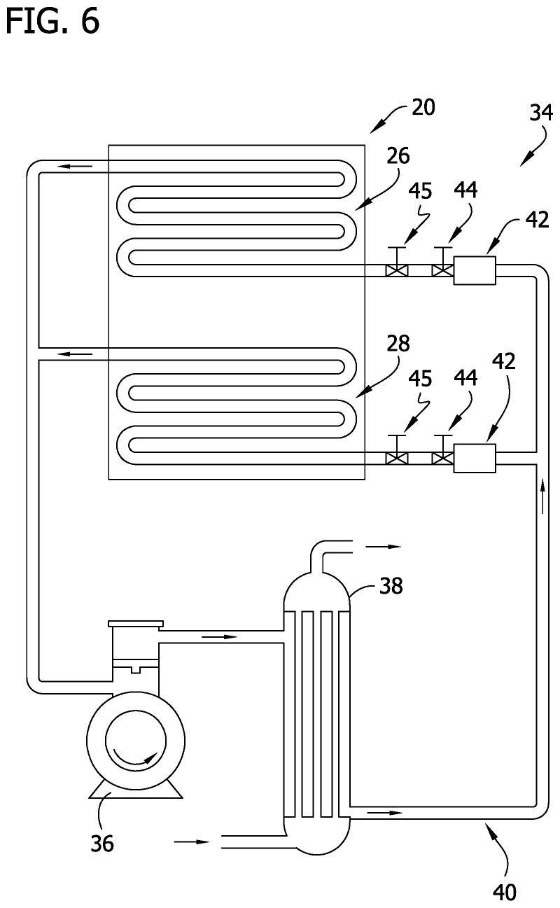

An exemplary refrigeration system 34 is shown schematically in FIG. 6. This schematic diagram corresponds to the food holding apparatus 10 having only one receiver 20 (e.g., only one set of first and second cooling coils 26, 28). As shown, the first and second cooling coils 26, 28 are distinct from one another. The first and second cooling coils 26, 28 are connected in parallel to the refrigerant supply system (e.g., compressor 36 and condenser 38). If the food holding apparatus 10 includes multiple receivers 20, such as the embodiment illustrated in FIGS. 1-5, 7 and 8, each receiver 20A-D (e.g., first and second cooling coils 26, 28) will have corresponding refrigerant metering valves 44, expansion valves 45 and refrigerant receivers 42. the plumbing 40 will include a first manifold between the condenser 38 and the refrigerant receivers 42 to distribute the refrigerant to each cooling coil 26, 28 and a second manifold between the cooling coils and the compressor 36 to collect the refrigerant from each cooling coil. Each refrigerant receiver 42 acts as a reservoir configured to hold an amount or supply of refrigerant and the refrigerant metering valve 44 can be actuated to selectively release the refrigerant held in the receiver to permit the refrigerant to flow through the corresponding expansion valve 45 and into the corresponding cooling coil 26, 28. As understood by persons having ordinary skill in the art, the amount of refrigerant released by the refrigerant metering valve 44 corresponds to the amount of cooling provided by the corresponding cooling coil 26, 28. For example, the more refrigerant released by the refrigerant metering valve 44 and flowing through the corresponding first or second cooling coil 26, 28, the more cooling provided by the respective cooing coil (e.g., a lower temperature can be reached). Each refrigerant metering valve 44 may be electronically controlled and include a prime mover (e.g., a servo motor, a solenoid, etc.) to open and close the valve. Refrigeration systems having other configurations are within the scope of the present disclosure. For example, refrigeration systems other than vapor-compression refrigeration systems may be used. For example, the refrigeration system may include a heat pump, Peltier device, solid state refrigerator, or thermoelectric cooler.

Each tray of food received in the one or more receivers 20 can be held in a refrigerated state or a frozen state. To refrigerate (e.g., hold the tray of food in a refrigerated state) the tray of food in the receiver 20, refrigerant can be supplied to one or both of the first and second cooling coils 26, 28. For example, refrigerant can be supplied to the first cooling coil 26, and not the second cooling coil 28, to refrigerate the tray of food. To freeze (e.g., hold the tray of food in a frozen state) the tray of food in the receiver 20, refrigerant can be supplied to one or both of the first and second cooling coils 26, 28. For example, refrigerant can be supplied to the first and second cooling coils 26, 28 to keep the tray of food frozen (i.e., delay thawing of the food for a substantial period of time, such as at least multiple hours). In the illustrated embodiment, the first cooling coil 26 is configured as a refrigeration cooling coil that holds the tray of food in a refrigerated state when refrigerant is supplied to the first cooling coil. The second cooling coil 28 is configured as a freezer cooling coil that hold the tray of food in a frozen state when refrigerant is supplied to the second cooling coil.

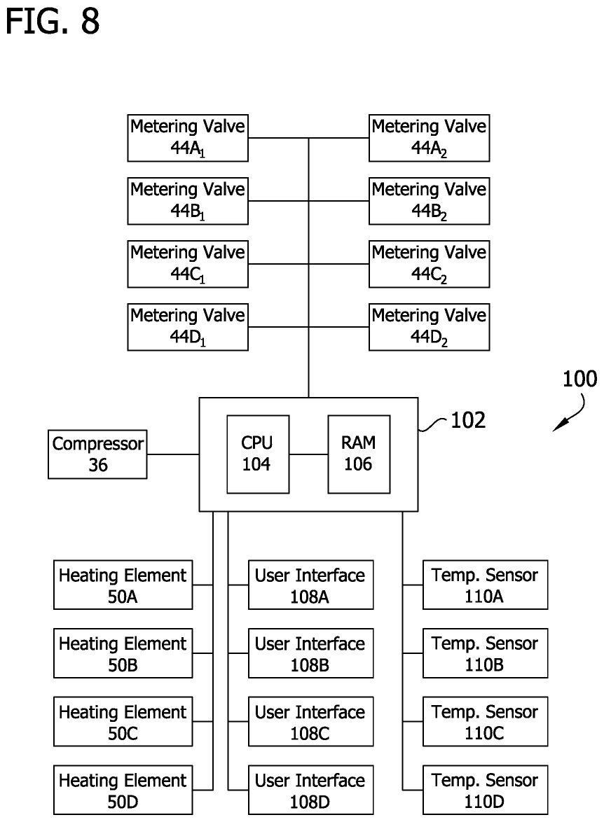

To control the flow of refrigerant through the first and second cooling coils 26, 28 for each receiver 20, the food holding apparatus 10 (e.g., the refrigeration system 34) includes a control system 100. As shown schematically in FIG. 8, the control system 100 includes a controller 102 (e.g., a temperature controller) having a CPU or processor 104 and RAM or memory 106 (broadly, non-transitory computer-readable storage medium). The controller 102 provides the computing engine that drives the operation of the food holding apparatus 10. Broadly, the memory 106 includes (e.g., stores) processor-executable instructions for controlling the operation of the processor 104. The instructions embody one or more functional aspects of the food holding apparatus 10 (e.g., the refrigeration system 34), as described herein, with the processor 104 executing the instructions to perform said one or more functional aspects.

In particular, the controller 102 is configured to control the temperature of each receiver 20, thereby keeping each tray of food at a desired temperature. The controller 102 is communicatively coupled to and responsive to a user interface 108 for controlling the temperature of each receiver 20. The user interface 108 can receive instructions or user input from a user, with the controller 102 carrying out the instructions. For example, the instructions from the user can include a desired set point temperature for each receiver 20. The set point temperature can be the temperature desired for the tray of food in the receiver, or can be a temperature of the heating or cooling element (or associated temperature) needed to achieve the desired temperature of the tray. The user interface 108 may include a display to display information to the user, such as the actual and/or set point temperature of the receiver 20. Any suitable user interface, such as a touch screen, is within the scope of the present disclosure. For example, the user interface may include different types of input devices (e.g., actuators) such as keyboards, mice, buttons, switches, or even microphones for receiving information from the user. The controller 102 is responsive to the user input via the actuator to control the temperature of each receiver 20 based on the set point temperature. In the illustrated embodiment, the food holding apparatus 10 includes four user interfaces 108A-D, each user interface corresponding to one of the receivers 20A-D.

The controller 102 is communicatively coupled to the compressor 36, the condenser 38, and the refrigerant metering valves 44A₁-D₂ (broadly, the refrigeration system 34) to selectively activate (e.g., operate) these components to cool each receiver 20 (e.g., supply the cooling coils 26, 28 with refrigerant) and/or hold the temperature of each receiver 20 according to the set point temperature. For example, the controller 102 may open one of the refrigerant metering valves 44 to supply one of the cooling coils 26, 28 with refrigerant until reaching the set point temperature. The controller 102 may then cycle the refrigerant metering valve 44 between open and closed positions to intermittently supply the cooling coil 26, 28 with refrigerant to hold the receiver 20. For example, a closed loop control algorithm may be used in which the valve 44 is opened when the temperature falls a threshold number of degrees below the set point and closed when the set point temperature is attained again. Temperature sensors 110A-D at each receiver 20 are communicatively coupled to the controller 102 to relay the current or actual temperature of each receiver (e.g., the cavity 22) to controller. For example, the temperature sensors 110A-110D can be mounted on a bottom of the pan 30 adjacent the heating element. The controller 102 uses the information (e.g., temperature signal) from each temperature sensor 110A-D to selectively activate (e.g., automatically activate) the compressor 36, activate the condenser 38, and/or the refrigerant metering valves 44A₁-D₂ as needed (e.g., control flow of refrigerant through the first and second cooling coils 26, 28) to individually cool each receiver 20 so that the actual temperature of each receiver matches the desired temperature for that receiver. Accordingly, each receiver 20 can be cooled independently of the other receivers.

The controller 102 is configured to operate the refrigeration system 34 (broadly, the food holding apparatus 10) in a plurality of different refrigeration modes. The user can use the user interface 108 (e.g., provide user input via the actuator) to instruct the controller 102 to operate the refrigeration system 34 in one of the plurality of different refrigeration modes. In a first refrigeration mode, the controller 102 is configured to operate and/or hold the receiver 20 in a refrigerated state. For example, in the first refrigeration mode, the controller 102 is configured to operate the refrigeration system 34 to cool the tray in the cavity 22 of the receiver 20 to a first temperature less than about 45 degrees F. (7 degrees C.). Desirably, the first temperature may be within an inclusive range of about 40 degrees F. (4 degrees C.) to about 34 degrees F. (1 degree C.). In the illustrated embodiment, the controller 102 controls the refrigeration system 34 (e.g., activates the compressor 36, activates the condenser 38, opens the refrigerant metering valve 44) to deliver or supply refrigerant to the first cooling coil 26, and not the second cooling coil 28, in the first refrigeration mode. In this embodiment, the flow of refrigerant through only the first cooling coil 26 is sufficient to cool the receiver to the refrigerated state. In other words, the first cooling coil 26 provides enough cooling to operate and/or hold the receiver 20 in the refrigerated state. In other embodiments, the controller 102 may direct refrigerant through both the first and second cooling coils 26, 28 or through the second cooling coil and not the first cooling coil to refrigerate the receiver 20 to the refrigerated state.

In a second refrigeration mode, the controller 102 is configured to operate and/or hold the receiver 20 in a frozen state. In the second refrigeration mode, the controller 102 is configured to operate the refrigeration system 34 to cool a tray in the cavity 22 of the receiver 20 to a second or freezing temperature. Of course the frozen state is cooler than the refrigerated state, thus the second temperature is cooler than the first temperature. In one embodiment, the second temperature is less than about 32 degrees F. (0 degrees C.). Desirably, the second temperature may be within an inclusive range of about 10 degrees F. (−12 degrees C.) and about 0 degrees F. (−18 degrees C.). In the illustrated embodiment, the controller 102 controls the refrigeration system 34 (e.g., activates the compressor 36, activates the condenser 38, opens the refrigerant metering valve 44) to deliver or supply refrigerant to the first cooling coil 26 and the second cooling coil 28, in the second refrigeration mode. In this embodiment, the flow of refrigerant through only the first cooling coil 26 may not be sufficient to cool the receiver 20 to the frozen state (e.g., to the second set point temperature), and thus refrigerant is flowed through the second cooling coil 28 to provide the additional cooling needed to reach the frozen state. In some embodiments, the second cooling coil 28 provides enough cooling to place and/or hold the receiver 20 in the frozen state, without needing any additional cooling from the first cooling coil 26. In this case, the controller 102 may direct refrigerant through the second cooling coil 28 and not the first cooling coil 26 to refrigerate the receiver 20 to the frozen state. Other refrigeration modes are within the scope of the present disclosure.

It will be appreciated that the set point temperatures used for the first and second modes may be lower than the desired temperatures of the food tray in the respective modes. For example, if the temperature sensor is located on the bottom of the pan 30, the temperature sensed at the sensor will need to be lower than the temperature at the tray. For example, the set point temperature may be 10 to 20 degrees F. lower than the desired temperature for the food tray.

In addition to cooling the receiver 20, the first cooling coil 26 may be further used to form a cold air blanket over the tray of food received in the receiver to insulate the tray of food from the surrounding atmosphere. For example, the first cooling coil 26 may be used to form a cold air blanket over the tray of food simultaneously with cooling the tray of food with the second cooling coil 28. Because the first cooling coil 26 is disposed adjacent to the upper end of the cavity 22, supplying the first cooling coil with refrigerant will both cool the tray of food and form a cold air blanket over the tray of food. Accordingly, the controller 102 may direct refrigerant through the first cooling coil 26 in order to cool the tray of food and/or form the cold air blanket over the tray of food. In order to form the cold air blanket, desirably, the cavity 22 is deep enough and the depth of the food in the tray is shallow enough such that when the tray of food is placed in the receiver, the first cooling coil 26 is disposed generally above the food. This results in the first cooling coil 26 primarily cooling the air disposed above the food to form the cold air blanket. If the food is level with or above the first cooling coil 26, the food may block the first cooling coil 26 from adequately cooling the air and forming the insulative cold air blanket (e.g., the food will be primarily cooled with the first cooling coil, not the air). The cold air blanket can be omitted (i.e., the food can be cooled and not air above the food) without departing from the scope of the present disclosure.

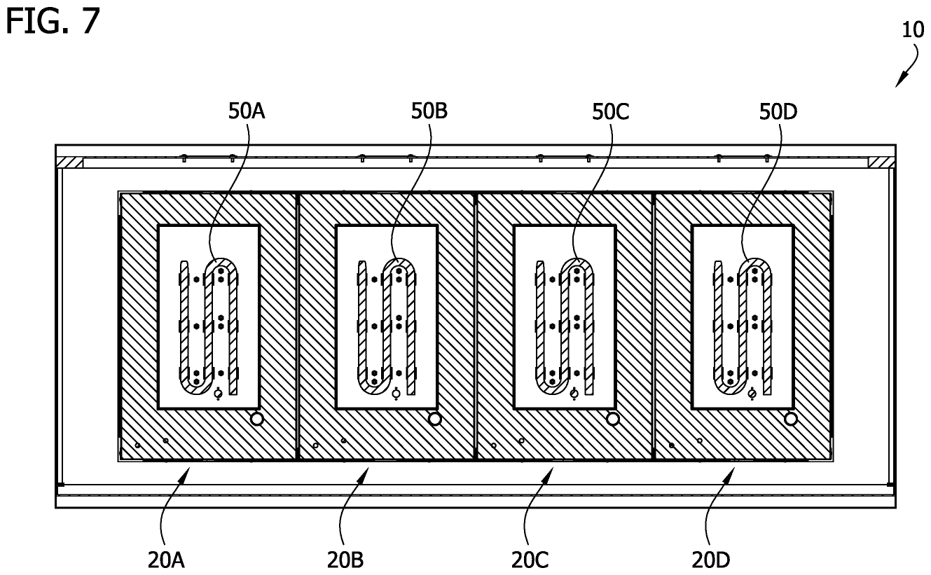

Referring to FIG. 7, each receiver 20 also includes a heating element 50 (broadly, a heater or food environment control device) configured to heat the tray of food when the tray of food is disposed in the cavity 22. Accordingly, in the illustrated embodiment, the food holding apparatus 10 includes four heating elements 50A-D. The heating element 50 is disposed between the pan 30 and housing 30, 32 and is generally adjacent the lower end of the cavity 22 (e.g., lower wall of the pan). In the illustrated embodiment, the heating element 50 is an electrical resistance heating element and, more specifically, is an electric bar heater. Other types of heating elements are within the scope of the present disclosure.

The heating elements 50A-D of each receiver 20A-D are communicatively coupled to the controller 102, which can selectively activate (e.g., operate) these elements to heat each receiver and/or hold the temperature of each receiver at the set point temperature. Using the information from the temperature sensors 110A-D, the controller 102 can selectively activate (e.g., automatically activate) the heating elements 34A-D as needed in order to individually heat each receiver 20 so that the actual temperature of each receiver matches the desired set point temperature for that receiver. Accordingly, each receiver 20 can be heated or cooled independently, regardless of whether any other receivers are being heated or cooled. For example, the first receiver 20A can be cooled to a refrigerated state (e.g., about 37 degrees F. (about 3 degrees C.)), the second receiver 20B can be cooled to a frozen state (e.g., about 2 degrees F. (about −17 degrees C.)), the third receiver 20C can be at room temperature (e.g., neither heated or cooled), and the fourth receiver 20D can be heated to a warming state (e.g., about 170 degrees F. (about 77 degrees C.)).

The controller 102 can control the temperature of each receiver 20 independently of the other receivers. For example, the temperature of on receiver 20 can be cold while the temperature of another receiver is hot. Accordingly, the temperature of each receiver 20 is independently controllable such that any combination of the receivers can be hot and/or cold. The controller 102 is configured to operate the heating element 34 and the refrigeration system 34 to selectively heat the cavity 22 of each receiver 20, refrigerate the cavity in the first refrigeration mode, or refrigerate the cavity in the second refrigeration mode. For example, if the controller 102 receives information from a temperature sensor 110 indicating the temperature of one of the receivers 20 is below the desired temperature (e.g., entered via the user interface 108), the controller can activate or increase the intensity (e.g., heat output) of the corresponding heating element 34 to raise the temperature of the receiver. After the actual temperature of the receiver 20 is raised to match the desired temperature, the controller 102 may deactivate or decrease the intensity of the corresponding heating element 34 to hold the temperature of the receiver (e.g., according to a hysteresis). Similarly, if the controller 102 receives information from a temperature sensor 110 indicating the temperature of one of the receivers 20 is above the desired temperature (e.g., the first or second set point temperatures depending upon the selected refrigeration mode), the controller can activate the necessary corresponding refrigerant metering valve(s) 44 to start or increase the flow of refrigerant through the corresponding cooling coil(s) 26, 28 to lower the temperature of the receiver. After the actual temperature of the receiver 20 is lowered, the controller 102 may activate the corresponding refrigerant metering valve 44 to shut off or decrease the flow of refrigerant to the corresponding cooling coil 26, 28 to hold the temperature of the receiver (e.g., according to a hysteresis). In addition, when cooling is required, the controller 102 can also activate the compressor 36 (broadly, the refrigerant supply system).

As used herein and in the drawings, when a reference character includes a reference numeral not followed by a letter, such a reference character refers to all elements designated at least in part by the reference numeral. Moreover, when a reference character includes the reference numeral followed by a letter, such as “A,” such a reference character refers to a particular element from the group of elements. For example, as used herein and in the drawings, the reference character “108” refers to all the user interfaces (e.g., 108A-D) designated at least in part with reference numeral “108” and the reference character “108A” refers to a specific one of the user interfaces such as the user interface associated with a specific receiver 20A.

The Title, Field of Disclosure, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field of Disclosure, and Background are not intended to identify key features or essential features of the claimed subject matter, nor is it intended to be used as an aid in determining the claimed subject matter.

The programs and other executable program components, such as the operating system, may be considered as discrete blocks. It is recognized, however, that such programs and components reside at various times in different storage components of a computing device, and are executed by a data processor(s) of the device.

Although described in connection with an exemplary computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the exemplary operating environment. Examples of receiver-known computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure is not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A food holding apparatus comprising:
a housing;
at least one food receiver supported by the housing, the at least one food receiver defining a cavity sized and shaped to receive a tray of food; and
a refrigeration system associated with the food receiver, the refrigeration system comprising:
a first cooling conduit arranged with respect to the receiver and configured to receive refrigerant to refrigerate the tray of food when the tray of food is disposed in the cavity of the food receiver;
a second cooling conduit arranged with respect to the receiver and configured to receive refrigerant to refrigerate the tray of food when the tray of food is disposed in the cavity of the food receiver;
a refrigerant supply system fluidly coupled to the first and second cooling conduits to supply the first and second conduits with refrigerant; and
a metering valve fluidly coupled to the second cooling conduit to selectively block and permit flow of refrigerant to the second cooling conduit such that refrigerant can flow through the first cooling conduit while refrigerant is blocked from flowing through the second cooling conduit.

2. The food holding apparatus of claim 1, wherein the refrigeration system includes a food holding apparatus temperature controller and a non-transitory tangible storage medium, the non-transitory tangible storage medium storing food holding apparatus temperature controller executable instructions, that when executed by the food holding apparatus temperature controller, selectively operate the refrigeration system in a first refrigeration mode in which refrigerant is delivered to the first cooling conduit and not the second cooling conduit, and in a second refrigeration mode in which refrigerant is delivered to the first cooling conduit and the second cooling conduit.

3. The food holding apparatus of claim 2, wherein the non-transitory tangible storage medium includes instructions to operate the refrigeration system in the first refrigeration mode to cool the cavity according to a first set point temperature, and to operate the refrigeration system in the second refrigeration mode to cool the cavity according to a second set point temperature, the second set point temperature being cooler than the first set point temperature.

4. The food holding apparatus of claim 2, wherein the refrigeration system includes a user interface comprising an actuator, the food holding apparatus temperature controller being responsive to user input via the actuator to operate in the first and second cooling modes.

5. The food holding apparatus of claim 1, wherein the first cooling conduit is disposed above the second cooling conduit.

6. The food holding apparatus of claim 5, wherein the first cooling conduit is adjacent to an upper end of the receiver, and the second cooling conduit is adjacent to a lower end of the receiver.

7. The food holding apparatus of claim 3, wherein the second cooling conduit underlies the cavity.

8. The food holding apparatus of claim 1, wherein the second cooling conduit is arranged to receive refrigerant in parallel with respect to the first cooling conduit.

9. The food holding apparatus of claim 1, wherein the metering valve is a second metering valve, and the refrigeration system includes a first metering valve fluidly coupled to the first cooling conduit, the first metering valve being configured to control an amount of refrigerant flowing through the first cooling conduit.

10. The food holding apparatus of claim 2, further comprising a temperature sensor communicatively coupled to the food holding apparatus temperature controller and configured to sense a temperature indicative of a temperature of the cavity of the receiver.

11. The food holding apparatus of claim 2, wherein the food holding apparatus temperature controller is responsive to a temperature signal from the temperature sensor to control flow of refrigerant through the first cooling conduit and the second cooling conduit.

12. The food holding apparatus of claim 2, further comprising a heating element arranged with respect to the receiver to heat the cavity for heating the tray of food when the tray of food is disposed in the cavity.

13. The food holding apparatus of claim 14, wherein the food holding apparatus temperature controller is configured to operate the heating element and the refrigeration system to selectively heat the cavity, refrigerate the cavity in the first mode, or refrigerate the cavity in the second mode.

14. The food holding apparatus of claim 1, wherein the at least one receiver comprises a plurality of receivers, each receiver defining a respective cavity for receiving a tray of food, the refrigeration system including a respective first cooling conduit and a respective second cooling conduit associated with each of the receivers.

15. A method of conditioning food, the method comprising:
positioning a tray containing the food in a cavity of a receiver of a food holding apparatus, the food holding apparatus including a first cooling conduit configured to refrigerate the tray of food in the cavity and a second cooling conduit configured to refrigerate the tray of food in the cavity, the first cooling conduit being arranged for refrigerant to flow therethrough while refrigerant is selectively blocked from flowing through the second cooling conduit; and
cooling the tray of food with at least one of the first cooling conduit or second cooling conduit.

16. The method of claim 18, wherein cooling the tray of food includes operating the food holding apparatus in one of a first refrigeration mode or a second refrigeration mode, wherein refrigerant is delivered to the first cooling conduit and not the second cooling conduit in the first refrigeration mode, and wherein refrigerant is delivered to the first and second cooling conduits in the second refrigeration mode.

17. The method of claim 19, wherein operating the food holding apparatus in the first refrigeration mode cools the cavity according to a first set point temperature, and operating the food holing apparatus in the second refrigeration mode cools the cavity according to a second set point temperature, the second set point temperature being lower than the first set point temperature.

18. The method of claim 20, wherein the first set point temperature is selected to cool the tray in the cavity to less than 45 degrees F. and the second set point temperature is selected to cool the tray in the cavity to less than 32 degrees F.

19. The method of claim 18, further comprising forming a cold air blanket over the tray of food with the first cooling conduit simultaneously with cooling the tray of food with the second cooling conduit.

20. The method of claim 19, wherein the first cooling conduit is adjacent to an upper end of the receiver and the second cooling conduit is adjacent to a lower end of the receiver.
